(19) United States
(12) Patent Application Publication
(10) Pub. No.: US 2007/0007056 A1
(43) Pub. Date: Jan. 11, 2007

(54) Low speed hybrid vehicle and control method thereof

(76) Inventors: Billy Bowers, Snellville, GA (US); Narayanan M. Subramanian, Marietta, GA (US)

Correspondence Address: NARAYANAN M. SUBRAMANIAN, 4251 CREEK HAVEN DR., MARIETTA, GA, 30062, US

(21) Appl. No.: 11/160,752

(22) Filed: Jul. 7, 2005

(51) Int. Cl. B60K 6/00

(52) U.S. Cl. 180/65.2

(57) ABSTRACT

A hybrid low power/low speed vehicle that operates both with battery power and IC engine power. An electronic controls unit monitors the charge on the battery. For vehicles used both indoors and outdoors, the control unit warns the user of low charge. If outdoors, the user can command the control unit to start the IC engine and continue operating the vehicle. The IC engine, while powering the wheels of the vehicle, will also charge the battery. When the battery is fully charged, the control unit will prevent the battery from overcharging. The user can shutoff the IC engine at any time and the control unit will switch to battery operation of the vehicle. For vehicles used exclusively outdoors, the control unit will automatically start the IC engine when the battery charge has fallen below a predetermined level. Similarly, once the battery is fully charged, it will automatically stop the engine and switch to battery power for running the vehicle.

### FIELD OF INVENTION

The present invention relates to multiple power sources and their control for low speed/low power vehicles. The invention more particularly relates to battery powered low speed/low power vehicles with internal combustion engine (IC engine) for auxiliary power and an electronic control unit to smoothly switch between battery power and IC engine power.

### BACKGROUND OF INVENTION

Low speed vehicles are operated by either battery powered electric motors or small IC engines. Examples of battery powered low speed vehicles are golf carts, utility vehicles, wheel chairs and low speed scooters. Examples of IC engine powered low speed vehicles are scooters and utility vehicles. Battery powered vehicles have a limited range due to the limited power capacity of the battery and must be recharged over a long period of time after a few hours of use. Hence wheelchair users on vacation are very restricted on how far they can go. Similarly, utility vehicles designed for a few hours of normal use cannot be used for an extended period of time even temporarily. Gasoline powered vehicles have a much longer range, but cannot be used indoors due to air pollution and noise pollution. Hence wheelchairs and utility vehicles used in hospitals cannot use IC engines as the sole power source. IC engine powered vehicles may not be welcome in certain stretches of camp grounds and other areas due to noise pollution. Hence there is a need for dual powered hybrid low speed/low power vehicles that can run on battery where IC engines cannot be used and switched to IC engine power outdoors when battery power must be conserved for later use or when the battery power is low.

There are two types of hybrid vehicles, namely, series hybrid and parallel hybrid. In a series hybrid vehicle, battery powered electric motor drives the wheels of the vehicle. The IC engine is used to drive a generator, which supplies power directly to the electric motor or charges the battery when the state of charge falls below a predetermined value. In parallel hybrid vehicles, the electric motor and the engine can drive the vehicle independently or in combination, pursuant to the running conditions of the vehicle. Typically, the control strategy for such parallel hybrid vehicles utilize the electric motor to drive the vehicle at low loads, the IC engine to drive the vehicle at intermediate loads, and the IC engine—electric motor combination to drive the vehicle at high loads. A number of patents have been issued for hybrid vehicles and means of switching between a motor and an IC engine based on load demand and speed. These patents have generally been for automobiles where the speeds vary from 0 mph to 80 or 90 mph and where the different load scenarios as explained above are continuously encountered. Some of these patents are U.S. Pat. No. 4,335,429 “Control apparatus for engine/electric hybrid vehicle” issued to Shiro Kawakatsu, U.S. Pat. No. 4,923,025 “Hybrid electric/ICE vehicle drive system” issued to Clarence W. Ellers, U.S. Pat. No. 5,495,906 “Controller of hybrid electric vehicle” issued to Masayuki Furutani, U.S. Pat. No. 6054776 “Control apparatus of parallel hybrid electric vehicle” issued to Yasuo Sumi, U.S. Pat. No. 6,712,165 “Hybrid vehicle” issued to Akihito Okazaki, U.S. Pat. No. 6,840,341 “Parallel hybrid vehicle” issued to Masato Fujikawa, U.S. Pat. No. 6,857,985, “Hybrid vehicle system” issued to Cameron P. Williams, U.S. Pat. No. 6,883,626 “Hybrid vehicle and control method thereof” issued to Kazuo Aoki et. al., U.S. Pat. No. 6,907,950 “Hybrid vehicle system” issued to Ikurou Notsu et. al.

In the case of low speed vehicles, the speeds vary from 0 mph to about 10 or 15 mph. Hence only the low load scenario of the parallel hybrid vehicle is encountered. The complexities of simultaneously engaging the IC engine and the electric motor as solved in the above mentioned patents do not occur here. But the control system should respond to the environment of the vehicle and accordingly use either the electric motor or the IC engine.

### SUMMARY OF INVENTION

The primary objective of the present invention is to come up with a simple low speed vehicle that overcomes the above mentioned deficiencies of range so that the user is not stranded in a place where there is no provision to recharge the battery powering the vehicle. Another objective is to keep the person mobile even if he/she does not have the time to get the battery recharged over an extended period of time. Yet another objective of the present invention is to keep the controls simple and easy to use.

The foregoing objective is attained by having an IC engine on standby and having an electronic control unit monitor the charge left in the battery. For vehicles used strictly outdoors such as golf carts, the control unit automatically starts the IC engine when the battery charge falls below a predetermined level. Irrespective of the type of hybrid vehicle, it executes a series of maneuvers to start the IC engine to power the vehicle and recharge the battery. For vehicles used both indoors and outdoors, the control unit warns the user of low charge on the battery. If the user instructs the electronic control unit to switch to IC engine mode, the control unit execute a series of operations to start the IC engine and power the vehicle as well as charge the battery.

In the ensuing description, the phrase ‘engine’ refers to IC engines running on a multitude of fuels such as gasoline, diesel, biogas, methanol, liquid petroleum gas (LPG) etc.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF DRAWINGS

FIG. 1 is a block diagram of a conventional battery powered low power/low speed vehicle.

FIG. 2 is a block diagram of a preferred embodiment of a hybrid low power/low speed vehicle.

FIG. 3 is a block diagram of the electrical control circuit for the operation of the hybrid low power/low speed vehicle of FIG. 2.

FIG. 4 is a block diagram of another embodiment of a hybrid low power/low speed vehicle.

FIG. 5 is a block diagram of the electrical control circuit for the operation of the hybrid low power/low speed vehicle of FIG. 4.

FIG. 6 is a block diagram of the electronic control unit for controlling the operation of an indoor/outdoor hybrid vehicle of FIG. 2 and FIG. 4.

FIG. 7 is a block diagram of the electronic control unit for controlling the operation of an outdoor hybrid vehicle of FIG. 2 and FIG. 4.

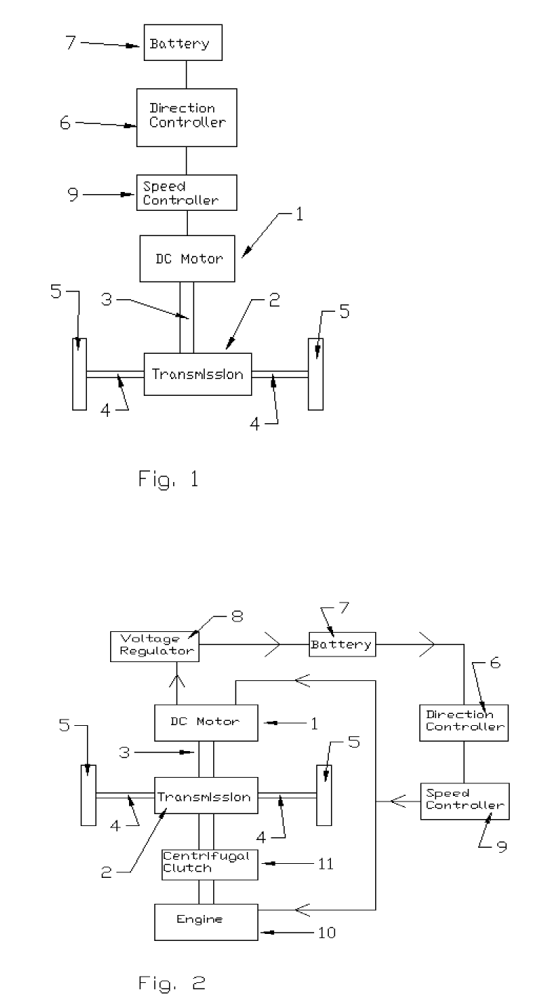

The numbering is kept consistent across FIG. 1 through FIG. 7 for clarity. Hence like reference numerals designate like parts.

### DETAILED DESCRIPTION OF THE INVENTION

FIG. 1 refers to the current state of the art for a battery powered low power/low speed vehicle like the golf cart, wheelchair, scooter etc. In this, battery 7 is connected via a direction controller 6 and a speed controller 9 to a D.C. (direct current) electric motor 1. The motor shaft 3 is connected to a transmission gear assembly 2, which in turn is connected to the wheels 5 via the axle 4. The speed of the electric motor is controlled by the speed controller 9, which in turn controls the speed of the vehicle. The direction controller 6 controls the rotational direction of the motor. This translates to forward and reverse movement of the vehicle.

FIG. 2 is a preferred embodiment of the present invention of a hybrid low power/low speed vehicle. In this, like in FIG. 1, the electric motor 1 is connected to the transmission gear assembly 2 through the motor shaft 3. The transmission gear assembly 2 is connected to the wheels 5 through the axle 4. An IC engine 10 is connected to the transmission gear assembly 2 via a centrifugal clutch 11. When the vehicle is running on battery power, the speed controller 9 regulates power supply from the battery to the DC motor, thereby regulating the speed of the vehicle. When the battery is low, the electric motor is stopped and the IC engine started. When the engine crankshaft is turning at a rate above the engine stall speed, the centrifugal clutch engages the crankshaft to the transmission. Thus the engine powers the wheels via the transmission. The engine also turns the DC motor, which acts as a generator and charges the battery via the voltage regulator 8. The same speed controller unit controls the motor speed during battery operation and the engine speed during IC engine operation. The electronic control unit of FIG. 6 controls the switching back and forth between electric motor and IC engine.

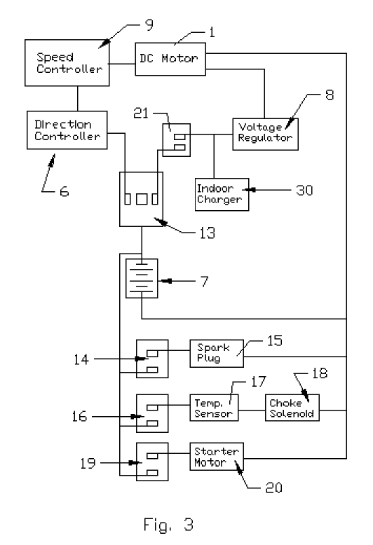

FIG. 3 is a block diagram of the electrical circuit for running the above-mentioned hybrid vehicle. Battery 7 is connected to the direction controller 6 via a mode selector relay 1 3. Normally the relay contacts are in the ‘Run’ mode, connecting the battery terminal to the speed controller 9 and the direction controller 6. This powers the dc motor and the vehicle moves. At this time, the vehicle is operated on battery power.

When the IC engine is running, the mode relay is in the “Charge’ mode. The DC motor acts as a DC generator, producing electricity. It charges the battery through the voltage regulator 8. The voltage regulator is connected to the battery via an overcharge protection relay 21. This relay trips when the battery is fully charged. The ignition relay 14 controls power to the spark plug 15 in the IC engine. The choke solenoid 18 is connected to the carburetor choke cable. It is used to ‘choke’ the engine for cold start. When the choke relay 16 is energized, the solenoid is activated via the temperature sensor switch 17. When the engine is hot, the temperature sensor switch trips and interrupts power to the solenoid, thereby preventing the choke from engaging. The starter motor 20 is powered by the starter relay 19. When the starter motor is energized, it turns the crankshaft of the engine and starts the engine. The electronic control unit in FIG. 6 operates the different relays that control the engine function as well as the charging function.

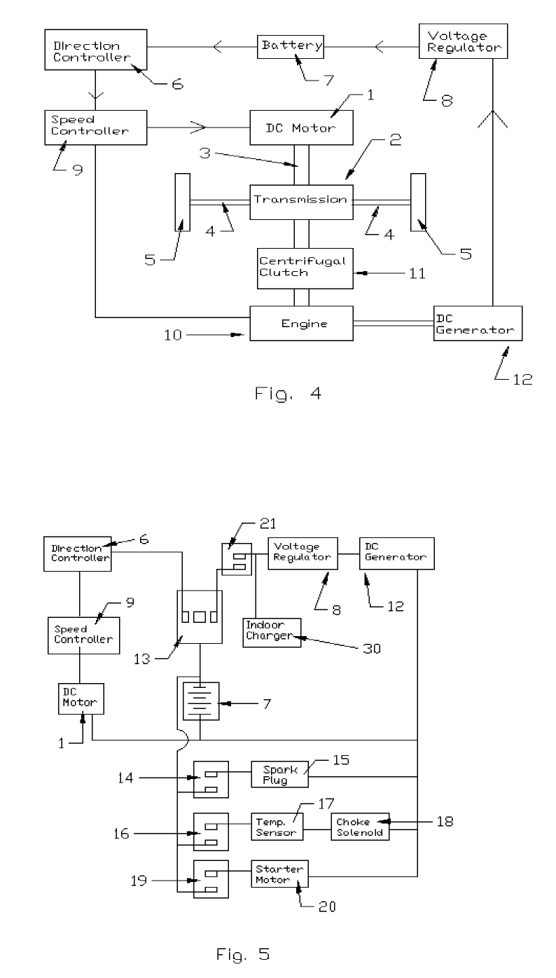

FIG. 4 is another preferred embodiment of the present invention of a hybrid low power/low speed vehicle. It is very similar to FIG. 2. Unlike in FIG. 2, where the DC motor acts as a generator during ‘Charge’ mode, in this embodiment, a separate DC generator 12 is used to charge the battery. So, when the mode relay is in the ‘Run’ mode, the DC motor powers the vehicle. When the mode relay is in the ‘Charge’ mode, the IC engine powers the vehicle as well as turns the DC generator, producing electricity to charge the battery.

FIG. 5 is a block diagram of the electrical circuit for running the hybrid vehicle of FIG. 4. The circuit is very similar to that in FIG. 3. Since there is a separate DC generator 12 in the embodiment of FIG. 4, the generator is connected to the ‘Charge’ terminal of the mode relay while the DC motor is connected to the ‘Run’ terminal of the mode relay.

FIG. 6 is a block diagram of the electronic control unit that controls the total operation of the hybrid vehicle. It relates to the controls for a vehicle that is operated both indoors and outdoors such as the wheelchair. It has a central control unit 29, receiving input from different sensors. Based on the input, it operates different relays to control the functions of the DC motor and the IC engine. In normal operating mode, when the vehicle is powered by the electric motor, the control unit monitors the battery voltage through the battery voltage sensor 24. When the battery voltage falls below a predetermined low voltage, it operates a buzzer 28 intermittently to warn the user of low battery voltage. If the vehicle is indoors, the user can plug the indoor charger 30 into the wall power outlet and charge the battery. When the control unit senses that the battery is being charged, it stops the buzzer from sounding an alarm. The control unit continues to monitor the battery voltage. When the voltage exceeds a predetermined high voltage, the control unit trips the overcharge protection relay 21 and protects the battery from overcharge.

If the vehicle is outdoors when the low voltage alarm goes off, the user can press the ‘Start Engine’ button 25. When the control unit gets this signal, it stops the buzzer from sounding an alarm. It operates the choke relay 16 to choke the engine for start. If the engine is hot, the temperature sensor switch 17 prevents the choke from being activated. The control unit then energizes the ignition relay 14. This will complete the electrical circuit for the spark plug. It switches the mode relay 13 to ‘Charge’ mode. It then operates the starter relay 19 for a few seconds. This activates the starter motor 20, which cranks the engine. A few seconds after the starter relay is deenergized, the control unit checks the input from the engine RPM sensor 22. If there is no signal from the sensor, the control unit energizes the starter motor again for a few seconds. This process is repeated till there is an input from the engine RPM sensor. When the engine reaches normal operating temperature, the temperature sensor 17 trips the solenoid 18 and releases the choke. Once the engine is running, the control unit starts monitoring the battery voltage through battery voltage sensor 24. The user can see the charge level by looking at the charge level indicator 32. When the battery voltage exceeds a predetermined high voltage, the control unit trips the overcharge protection relay 21 to protect the battery. But the engine continues to run. When the user wants to cut off the engine, he can press the ‘Stop Engine’ button 26. When the control unit gets the ‘Stop Engine’ signal, it trips the ignition relay to stop the spark plug from firing. This stops the engine. It then switches the mode relay to the ‘Run’ mode. It switches off the choke relay.

When the battery voltage is above the predetermined low voltage, if the user needs extra power to climb an incline, or if the user decides to conserve battery power for later use indoors, he can switch to engine power by pressing the ‘Start Engine’ button. In this case also, as before, the control unit will go though the above mentioned procedure to start the engine and charge the battery to full capacity. The engine, as above will continue to run even after the battery is fully charged till the user presses the ‘Stop Engine’ button.

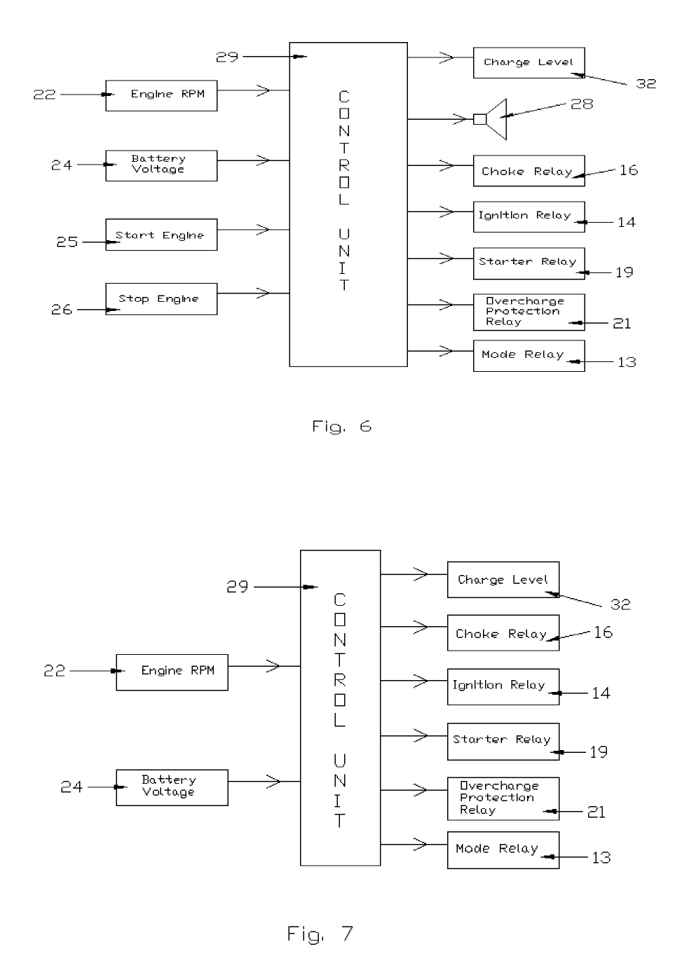

FIG. 7 is a block diagram of the electronic control unit that controls the total operation of a hybrid vehicle operated exclusively outdoors such as the golf cart. It is very similar to FIG. 6. Since it is an outdoor vehicle, the control unit starts the engine automatically when the battery charge falls below a predetermined level. Hence it does not have a buzzer to warn the user of low battery power. When the battery charge falls below a predetermined level, the control unit automatically goes through all the operations mentioned above as if it received a ‘Start Engine’ signal. Thus the battery is automatically charged. When the battery is fully charged, the control unit shuts off the engine and trips the mode relay to ‘Run’ mode, thereby running the vehicle on battery power. All this is done automatically without user intervention.

What is claimed is:

1. A low speed, low power vehicle that has:
an electric motor as the primary motive power;
an alternate source as the secondary motive power;
a set of wheels for the vehicle to move;
a transmission to couple said primary motive power and said secondary motive power with said wheels of said vehicle;
a clutch to selectively engage said secondary motive power to said transmission;
battery to energize said electric motor;
a generator to charge said battery;
a control unit to monitor and control the operation of said primary motive power and said secondary motive power.

2. A clutch of claim 1 where said clutch is a centrifugal clutch.

3. A generator of claim 1 where said generator is rotated by said secondary motive power.

4. A control unit of claim 1 where said control unit monitors available charge in said battery.

5. A control unit of claim 4 where said control unit switches from said primary motive power to said secondary motive power automatically when said battery charge is below predetermined level.

6. A control unit of claim 4 where said control unit warns operator when said battery charge is below predetermined level.

7. A control unit of claim 6 where said control unit is responsive to said operator directive to switch from said primary motive power to said secondary motive power.

8. A control unit of claim 4 where said control unit monitors charging of said battery by said generator.

9. A control unit of claim 8 where said control unit stops overcharging of said battery by said generator when said battery has reached full charge.

10. A control unit of claim 9 where said control unit switches from said secondary motive power to said primary motive power automatically when said battery is fully charged.

11. A control unit of claim 9 where said control unit is responsive to said operator directive to switch from said secondary motive power to said primary motive power.

12. A secondary motive power of claim 1 where said secondary motive power is an internal combustion engine.

13. A control unit of claim 5 where said control unit starts said internal combustion engine automatically when said battery charge is below predetermined level.

14. A control unit of claim 13 where said control unit repeatedly starts said internal combustion engine when said internal combustion engine is not running on start commands.

15. A control unit of claim 14 where said control unit automatically stops said internal combustion engine when said battery is fully charged.

16. A control unit of claim 15 where said control unit switches said vehicle to said primary motive power when said internal combustion engine is stopped.

17. A control unit of claim 7 where said control unit starts said internal combustion engine in response to said operator directive.

18. A control unit of claim 17 where said control unit repeatedly starts said internal combustion engine when said internal combustion engine is not running on start commands.

19. A control unit of claim 18 where said control unit stops said internal combustion engine in response to said operator directive.

20. A control unit of claim 19 where said control unit switches said vehicle to said primary motive power when said internal combustion engine is stopped.
